(19) United States
(12) Patent Application Publication
(10) Pub. No.: US 2025/0076996 A1
(43) Pub. Date: Mar. 6, 2025

(54) LABELING METHOD AND APPARATUS FOR ESTIMATING 6 DEGREES OF FREEDOM OF OBJECT

(71) Applicants: Electronics and Telecommunications Research Institute, Daejeon (KR); SEOUL NATIONAL UNIVERSITY HOSPITAL, Seoul (KR)

(72) Inventors: Eun-ju JEONG, Daejeon (KR); Young-Gon KIM, Seoul (KR); Seungjae CHOI, Seoul (KR); Seyeon PARK, Seoul (KR); Jongho SHIN, Seoul (KR)

(21) Appl. No.: 18/673,236

(22) Filed: May 23, 2024

(30) Foreign Application Priority Data
May 23, 2023 (KR) 10-2023-0066435
May 22, 2024 (KR) 10-2024-0066429

(51) Int. Cl. G06F 3/0346; G06T 7/62; G06T 7/70; G06V 20/70

(52) U.S. Cl. CPC G06F 3/0346; G06T 7/62; G06T 7/70; G06V 20/70

(57) ABSTRACT

A labeling method and system for estimating six degrees of freedom (6DoF) of an object are provided. The method includes identifying a center coordinate of an object included in an image, converting the center coordinate into object location information in a real space, and visualizing 6DoF of the object by labeling the 6DoF based on the object location information.

### CROSS-REFERENCE TO RELATED APPLICATION

This application claims the benefit of Korean Patent Application No. 10-2023-0066435, filed on May 23, 2023, and Korean Patent Application No. 10-2024-0066429, filed on May 22, 2024, in the Korean Intellectual Property Office, the entire disclosures of which are incorporated herein by reference for all purposes.

### BACKGROUND

### 1. Field of the Invention

One or more embodiments relate to a labeling method and device for estimating six degrees of freedom (6DoF) of an object, and more particularly, to a method and system for labeling 6DoF of a three-dimensional (3D) object displayed on a two-dimensional (2D) image.

### 2. Description of the Related Art

Amid changes in a product manufacturing environment, the need for flexible production using autonomous robots has increased to enhance business competitiveness. It is important to develop multi-robot autonomous manufacturing technology that may quickly place existing equipment robots into new products and processes without building a new manufacturing line and manufacturing environment whenever products and processes change.

Here, deep learning technology of recognizing a three-dimensional (3D) posture (position, direction) of products/parts/equipment/robots using two-dimensional (2D) and 3D images shows excellent accuracy and high speed in a simulation environment. However, deep learning technology requires annotations that include location and direction information (six degrees of freedom (6DoF)) of an object included in images required for training.

However, in a conventional labeling system, in order to annotate an object included in an image, a user needs to directly label the object, identify the location and direction of the object, and annotate the location and direction of the identified object, and thus, it takes a lot of time and costs to generate a data set including images required for training.

In addition, in the conventional labeling system, a user writes annotations so that the quality of the annotations varies depending on the user. Therefore, issues may arise with accuracy and consistency of annotated data, and this may affect model performance.

Furthermore, real-time annotations are required to perform real-time 6DoF estimation in a real environment, but real-time annotation using human resources requires a large number of personnel and high costs, making real-time estimation difficult.

Therefore, there is a demand for a method of automatically adding annotations to estimate 6DoF of an object.

### SUMMARY

Embodiments provide a method and system for efficiently estimating three-dimensional (3D) location information and a rotation value of an object by accurately determining the location and rotation of the object using a center coordinate on an image, image resolution, and size information in a real space.

In addition, embodiments provide a method and system for reducing time and cost of annotating large amounts of data on an object by labeling six degrees of freedom (6DoF) of the object, storing a coordinate value of the 6DoF of the object as a text file, and displaying an interface where annotations may be entered according to a stored 6DoF coordinate value.

According to an aspect, there is provided a labeling method of estimating 6DoF of an object, the labeling method including identifying a center coordinate of an object included in an image, converting the center coordinate into object location information in a real space, and visualizing 6DoF of the object by labeling the 6DoF based on the object location information.

The converting of the center coordinate may include determining a size of a real space corresponding to a pixel of the image based on an actual size of a space, where the object is located in a real space, and resolution of the image and determining the object location information in the real space based on the center coordinate of the object and the size of the real space corresponding to the pixel of the image.

The determining of the object location information may include determining an x value of the object location information in the real space using an X value of the center coordinate, an actual horizontal length of a space visible on the image, and a resolution horizontal value of the image.

The determining of the object location information may include determining a y value of the object location information in the real space using a Y value of the center coordinate, an actual vertical length of a space visible on the image, and a resolution vertical value of the image.

The determining of the object location information may include determining a z value of the object location information in the real space by inputting an x value of the object location information in the real space and a y value of the object location information in the real space to a matrix representing a relationship between the x value of the object location information in the real space, the y value of the object location information in the real space, and the z value of the object location information in the real space.

The labeling method may further include determining a camera parameter representing a relationship between a camera and the object based on information about a location and rotation of the camera, the object location information in the real space, and information about the rotation, and the visualizing of the 6DoF may include labeling a location of the object existing in three-dimensions in the image of two-dimensions by applying a camera parameter to the object location information in the real space and performing visualization.

The visualizing of the 6DoF may include displaying an interface for inputting annotations according to the object location information in the real space and the information about the rotation.

According to another aspect, there is provided a labeling device for estimating 6DoF of an object, the labeling device including a value movement portion configured to identify a center coordinate of an object included in an image, a converter configured to convert the center coordinate into object location information in a real space, and a visualizer configured to visualize 6DoF of the object by labeling the 6DoF based on the object location information.

The converter may be further configured to determine a size of a real space corresponding to a pixel of the image based on an actual size of a space, where the object is located in a real space, and resolution of the image and determine the object location information in the real space based on the center coordinate of the object and the size of the real space corresponding to the pixel of the image.

The converter may be further configured to determine an x value of the object location information in the real space using an X value of the center coordinate, an actual horizontal length of a space visible on the image, and a resolution horizontal value of the image.

The converter may be further configured to determine a y value of the object location information in the real space using a Y value of the center coordinate, an actual vertical length of a space visible on the image, and a resolution vertical value of the image.

The converter may be further configured to determine a z value of the object location information in the real space by inputting an x value of the object location information in the real space and a y value of the object location information in the real space to a matrix representing a relationship between the x value of the object location information in the real space, the y value of the object location information in the real space, and the z value of the object location information in the real space.

The visualizer may be further configured to determine a camera parameter representing a relationship between a camera and the object based on information about a location and rotation of the camera, the object location information in the real space, and information about the rotation and label a location of the object existing in three-dimensions in the image of two-dimensions by applying a camera parameter to the object location information in the real space and perform visualization.

The visualizer may be further configured to display an interface for inputting annotations according to the object location information in the real space and the information about the rotation.

Additional aspects of embodiments will be set forth in part in the description which follows and, in part, will be apparent from the description, or may be learned by practice of the disclosure.

According to an embodiment of the present disclosure, a labeling method of estimating 6DoF of an object may include efficiently estimating 3D location information and a rotation value of the object by accurately determining the location and rotation of the object using a center coordinate on an image, image resolution, and size information in a real space.

In addition, according to an embodiment of the present disclosure, the labeling method may reduce time and cost of annotating large amounts of data on an object and may be easily used even by a user without related knowledge, by labeling 6DoF of the object, storing a coordinate value of the 6DoF of the object as a text file, and displaying an interface where annotations may be entered according to the stored 6DoF coordinate value.

Furthermore, according to an embodiment of the present disclosure, since the time to annotate data is reduced, the total research time may also be reduced.

### BRIEF DESCRIPTION OF THE DRAWINGS

These and/or other aspects, features, and advantages of the invention will become apparent and more readily appreciated from the following description of embodiments, taken in conjunction with the accompanying drawings of which:

FIG. 1 is a diagram illustrating a labeling device for estimating six degrees of freedom (6DoF) of an object, according to an embodiment;

FIG. 2 is an example of an image input to a labeling device for estimating 6DoF of an object, according to an embodiment;

FIG. 3 is an example of a result of visualizing 6DoF of an object by a labeling device for estimating 6DoF of an object, according to an embodiment; and

FIG. 4 is a flowchart illustrating a labeling method of estimating 6DoF of an object, according to an embodiment.

### DETAILED DESCRIPTION

Hereinafter, embodiments will be described in detail with reference to the accompanying drawings. A labeling method of estimating six degrees of freedom (6DoF) of an object according to an embodiment of the present disclosure may be performed by a labeling device for estimating 6DoF of an object.

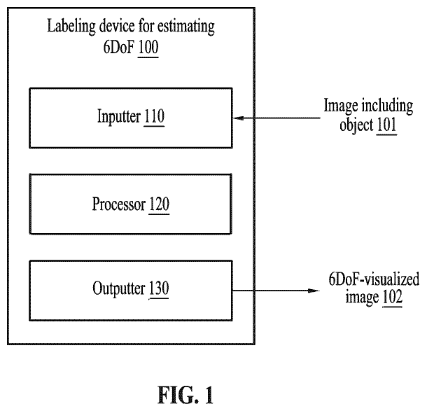

FIG. 1 is a diagram illustrating a labeling control device for estimating 6DoF of an object, according to an embodiment.

A labeling control device 110 for estimating 6DoF of an object may include an inputter 110, a processor 120, and an outputter 130, as shown in FIG. 1.

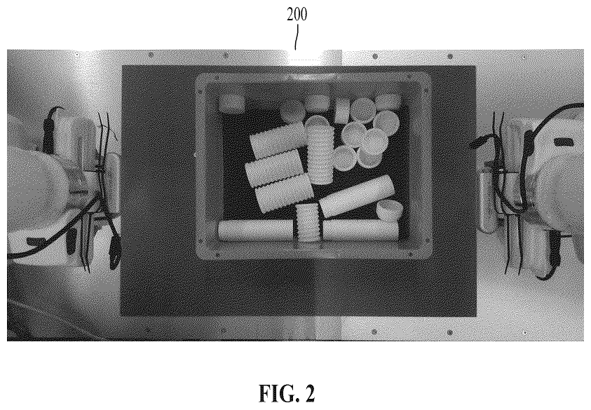

The inputter 110 may receive an image 101 including an object to be labeled. For example, the inputter 110 may include an interface that may be connected to an internal storage medium of the labeling control device 100 for estimating 6DoF of an object or an external storage medium, by wire or wirelessly, or may include an interface that may receive the image 101 including the object to be labeled, by wire or wirelessly. For example, the image 101 including the object to be labeled may be an image 200 shown in FIG. 2.

The inputter 110 may include an order transmitter for storing file names of predefined images in a list format when running a program and an image loader for loading images into the program through the file names of the images transmitted from the order transmitter and a folder path in which the images are stored. For example, a default value transmitted by the order transmitter may be a file name in the first order in the list of the stored file names. The image loader may read the images using the transmitted file names and a predefined folder path using an open source computer vision library (OpenCV) and may display the images on a program screen.

The processor 120 may label 6DoF of the image 101 including the object to be labeled and may determine a 6DoF-visualized image 102. 6DoF represents a total of 6DoF in which an object may move freely, including three movements of pitching, rolling, and yawing of a moving object in a three-dimensional (3D) rectangular coordinate system and three movements of left and right movements, forward and backward movements, and up and down movements in which an object moves parallel to each axis. That is, the processor 120 may label x-axis, y-axis, and z-axis coordinates of an object according to 3D coordinates of the object and direction information (angle) based on each axis of the object and may display the x-axis, y-axis, and z-axis coordinates and the direction information on an image.

The processor 120 may include a value movement portion, a converter, and a visualizer. Here, the value movement portion, the converter, and the visualizer are different processors. The processor 120 may be a device including a plurality of processors, and the value movement portion, the converter, and the visualizer may each be a module included in a program executed by one processor 120.

The value movement portion may identify a center coordinate of an object included in the image 101 including the object to be labeled. When a user changes a value within a predefined range using a keyboard or mouse, the value movement portion may determine the location of the center of a specific object shown in the image based on the changed value. Here, the center coordinate refer to X, Y, and Z values of the pixel location representing the center point of the object.

The converter may convert the center coordinate identified by the value movement portion into object location information in a real space. For example, the converter may use Equation 1 to determine Realₓ, which is an x value of the object in the real space (a 3D space), and may use Equation 2 to determine Real_{y}, which is a y value of the object in the real space (a 3D space).

$${Real}_{x} = - H / 2 + {P}_{X} * {P}_{R H} \qquad [ Equation 1 ]$$

$${Real}_{y} = - V / 2 + {P}_{Y} * {P}_{RV} \qquad [ Equation 2 ]$$

Here, P_{RH} may be defined as shown in Equation 3 and P_{RV} may be defined as shown in Equation 4. In addition, H may be the actual horizontal length of a space visible on the image 101 and V may be the actual vertical length of a space visible on the image 101. Furthermore, P_{X} may be an X value of the center coordinate on the image and P_{Y} may be a Y value of the center coordinate on the image.

$${P}_{RH} = H / resolution horizontal length of image \qquad [ Equation 3 ]$$

$${P}_{RV} = V / resolution vertical length of image \qquad [ Equation 4 ]$$

In addition, the converter may determine Realₓ, which is the x value of the object in the real space (a 3D space) using Equation 5 or may also determine Real_{y}, which is the y value of the object in the real space (a 3D space) using Equation 6.

$${Real}_{x} = ( {NP}_{X} - 2 N ) \cdot H \qquad [ Equation 5 ]$$

$${Real}_{y} = ( M {P}_{Y} - 2 M ) \cdot V \qquad [ Equation 6 ]$$

Here, N may be a horizontal resolution value (the number of pixels) of the image and M may be a vertical resolution value (the number of pixels) of the image.

In addition, the converter may determine Real_{z}, which is a z value of the object in the real space (a 3D space) using a matrix Pᵣₑₐₗ for the object location in the real space. Specifically, the converter may train the matrix Pᵣₑₐₗ for the object location in the real space that represents the relationship between Realₓ, Real_{y}, and Real_{z} as shown in Equation 7, using training data including a plurality of samples. Here, the training data may include the object location in the real space (a 3D space) and image data of the object. In addition, each of the samples included in the training data may include pixel coordinates (P_{X}, P_{Y}) and real space coordinates (Realₓ, Real_{y}, Real_{z}) on the image.

$${P}_{real} = [ \begin{matrix}{Real}_{x} \\ {Real}_{y} \\ {Real}_{z}\end{matrix} ] \qquad [ Equation 7 ]$$

In addition, the converter may determine Realₓ and Real_{y} of each of the samples using image data included in each of the samples of the training data. Subsequently, the converter may train the matrix Pᵣₑₐₗ by modeling the relationship between Realₓ and Real_{y} of each of the samples and the object location in the real space included in each of the samples of the training data. For example, the converter may train the matrix Pᵣₑₐₗ using methods such as linear regression and neural networks.

In addition, the converter may input Realₓ and Real_{y} determined by the converter into a matrix Rᵣₑₐₗ using the image 101 to determine Real_{z} corresponding to Realₓ and Real_{y}.

That is, the converter may include a conversion matrix T_{obj} for converting P_{X} that is the X value of the center coordinate (a pixel coordinate) of the image, P_{Y} that is the Y value of the center coordinate (a pixel coordinate) of the image, and P_{Z} that is a Z value of the center coordinate (a pixel coordinate) of the image into Realₓ that is the x value of the object in the input real space (a 3D space), Real_{y} that is the y value of the object in the real space (a 3D space), and Real_{z} that is the z value of the object in the real space (a 3D space), as shown in Equation 8.

$$( \begin{matrix}{Real}_{x} \\ {Real}_{y} \\ {Real}_{z}\end{matrix} ) = {T}_{obj} ( \begin{matrix}{P}_{X} \\ {P}_{Y} \\ {P}_{Z}\end{matrix} ) \qquad [ Equation 8 ]$$

In addition, the converter may determine a rotation value representing a value about the 3D location and rotation (Euler angle) of the object. Specifically, the converter may input a Euler angle (α,β,γ), which is included in the training data in a trained rotation conversion matrix R_{obj} or extracted from the image 101, to convert the Euler angle (α,β,γ) into rotation values (θₓ, θ_{y}, θ_{z}). For example, the rotation conversion matrix R_{obj} may be defined as shown in Equation 9.

$$( \begin{matrix}{θ}_{X} \\ {θ}_{y} \\ {θ}_{z}\end{matrix} ) = {R}_{obj} ( \begin{matrix}α \\ β \\ γ\end{matrix} ) \qquad [ Equation 9 ]$$

The rotation value represents a 3D posture of the object and is defined in the same coordinate system as Realₓ, Real, Real_{z} values. Accordingly, since Realₓ, Real_{y}, Real_{z} converted from the converter and the rotation values θₓ, θ_{y}, θ_{z} are values determined in the same coordinate system, the location and posture of the object may be expressed simultaneously.

Here, the converter may determine the size of the real space corresponding to the pixels of the image based on the actual size of the space in which the object is located in the real space and the resolution of the image. In addition, the converter may determine the object location information in the real space based on the center coordinate of the object and the size of the real space corresponding to the pixels of the image.

In addition, the converter may determine the center coordinate (horizontal, vertical, and height) values of the object in the real space and the rotation value of the object.

Specifically, the converter may determine the size of the real space represented by 1 pixel by dividing the actual size of a space where the image is captured by the resolution of the predefined image using information from a camera that captures the predefined image. Here, the converter may determine the location of the object in the real space shown in the image by multiplying the object center coordinate (horizontal, vertical) values obtained through the value movement portion by the size of the real space represented by 1 pixel.

Here, Z axis (height) of the object may correspond 1:1 to the height of an actual object. In addition, the rotation value determined by the converter represents the Euler angle and the three values may have values representing each rotation axis of the Euler angle.

The visualizer may visualize a 3D box on the object in the image 101 using the actual location value, the 3D size of the object, and the camera parameter obtained by the converter. Here, the visualizer may visualize the camera parameter representing the relationship between the object and the camera and the size of the predefined object on an image in which a box projected in the form of a hexahedron is loaded.

Specifically, the visualizer requires the actual size of the predefined object in the 3D space and the camera parameter to visualize, on the image 101, the actual location in the 3D space and the information about the rotation obtained using the value movement portion and the converter. For example, the visualizer may define the Euler angle in the value movement portion and the converter as a rotation matrix M_{obj} using SciPy.

In addition, the visualizer may determine Cam_{obj} that is the camera parameter representing the relationship between the camera and the object, using T_{cam} that is the information (a matrix) about the location of the camera in the 3D space, M_{cam} that is the information (a rotation value) about the rotation of the camera, T_{obj} that is the object location information (a matrix) in the real space, and M_{obj} that is the information (a rotation conversion matrix) about the rotation of the object. For example, the visualizer may determine Cam_{obj} using Equation 10.

$${Cam}_{obj} = [ \begin{matrix}{M}_{cam} & {T}_{cam} \\ \begin{matrix}0 & 0 & 0\end{matrix} & 1\end{matrix} ] [ \begin{matrix}{M}_{obj} & {T}_{obj} \\ \begin{matrix}0 & 0 & 0\end{matrix} & 1\end{matrix} ] \qquad [ Equation 10 ]$$

In addition, the visualizer may apply Cam_{obj}, the actual size in the 3D space of the predefined object, and an intrinsic parameter of the camera to OpenCV, thereby performing labeling on the location of the object in the 3D space in the two-dimensional (2D) image by visualizing the location of the object corresponding to a value set by the value movement portion in the image 101.

In addition, the processor may further include a storage for generating the name of the object, the actual location of the object, the Euler angle, and coordinate values of the upper left and lower right of a 2D bounding box in a dictionary format and storing them with a javascript object notation (JSON) extension. For example, the storage may save a 6DoF coordinate value of the object as a text file.

In addition, the storage may identify the 3D location of the object visualized by the visualizer and the location and rotation value of the object set by moving the value through the value movement portion. Furthermore, the storage may store the type of the object, the location of the object in the 3D space, and the rotation in the 3D space expressed as the Euler angle.

In addition, 2D bounding box information of the object may be determined through the visualizer.

The outputter 130 may display the image 102 in which the 6DoF is visualized on a display of the labeling control device 100 for estimating the 6DoF of the object or may transmit the image 102 to a terminal requested by a user. In addition, the outputter 130 may display an interface for inputting annotations according to the stored 6DoF coordinate values. Here, the 6DoF coordinate values may be x-axis, y-axis, and z-axis coordinates of the object included in the object location information in the real space and the direction information (angle) based on each of x-axis, y-axis, and z-axis of the object included in the rotation information.

The labeling device for estimating 6DoF of an object according to an embodiment of the present disclosure may reduce time and cost of annotating large amounts of data on an object and may be easily used even by a user without related knowledge, by labeling the 6DoF of the object, storing a coordinate value of the 6DoF of the object as a text file, and displaying an interface where annotations may be entered according to the stored 6DoF coordinate value. In addition, the labeling device for estimating the 6DoF of the object according to an embodiment of the present disclosure may reduce the total research time since the time to annotate data is reduced.

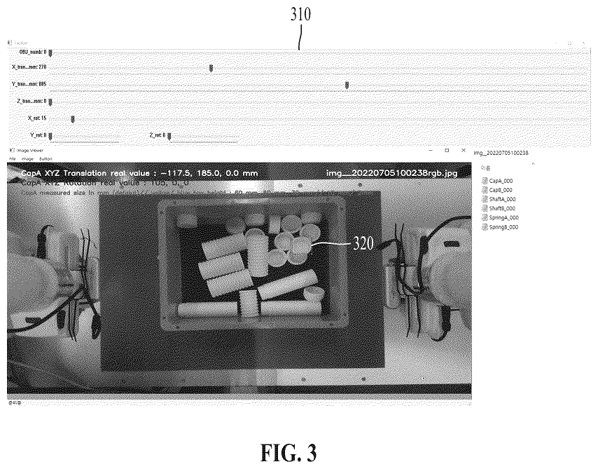

FIG. 3 is an example of a result of visualizing 6DoF of an object labeled by a labeling device for estimating 6DoF of an object, according to an embodiment.

When a user changes a value within a predefined range through an interface 310 of FIG. 3, a value movement portion may determine the location of the center of a specific object shown in an image, based on the changed value. Here, a center coordinate refers to pixel location representing the center point of the object.

In addition, the converter may convert the center coordinate identified by the value movement portion into object location information in a real space.

Finally, the visualizer may visualize the 6DoF of the object using an actual location value obtained by the converter, the 3D size of the object, and a camera parameter. Here, the visualizer may determine a relationship value between the object and a camera using the 6DoF of the labeled object, the size of the object, and the camera parameter. Furthermore, the visualizer may visualize the relationship value between the object and the camera and the size of the predefined object on an image loaded with a box 320 projected in the form of a hexahedron.

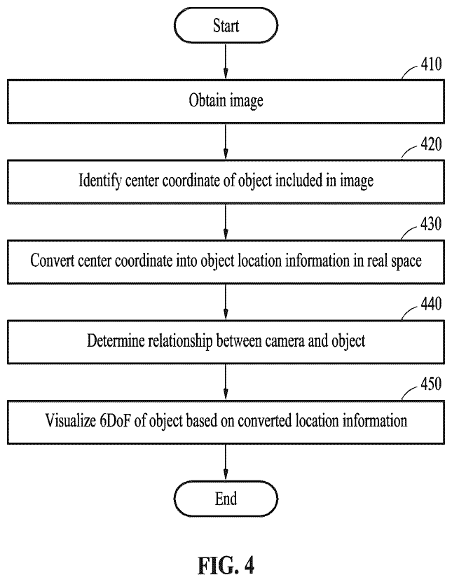

FIG. 4 is a flowchart illustrating a labeling method of estimating 6DoF of an object, according to an embodiment.

In operation 410, the inputter 110 may receive the image 101 including an object to be labeled.

In operation 420, the processor 120 may identify a center coordinate of the object included in the image input in operation 410.

In operation 430, the processor 120 may convert the center coordinate identified in operation 420 into object location information in a real space. Here, the processor 120 may determine the size of the real space corresponding to a pixel of the image based on the actual size of a space where the object is located in the real space and resolution of the image. Subsequently, in operation 420, the object location information in the real space may be determined based on the center coordinate of the object and the size of the real space corresponding to the pixel of the image.

In operation 440, the processor 120 may determine a camera parameter representing a relationship between a camera and the object based on information about the location and rotation of the camera and information about the location and rotation of the object. Specifically, the processor 120 may determine Cam_{obj} that is the camera parameter using T_{cam} that is information (a matrix) about the location of the camera in a 3D space, M_{cam} that is information (a rotation value) about the rotation of the camera, T_{obj} that is the object location information (a matrix) in the real space, and M_{obj} that is information (a rotation conversion matrix) about the rotation of the object.

In operation 450, the processor 120 may visualize the 6DoF of the object using the actual location value determined in operation 430, the 3D size of the object, and the camera parameter determined in operation 440.

Here, the processor 120 may visualize a box in which the size of the predefined object is projected in the form of a hexahedron on the image by referring to the camera parameter.

The labeling method of estimating 6DoF of an object of the present disclosure may provide efficiently estimating 3D location information and a rotation value of the object by accurately determining the location and rotation of the object using a center coordinate on an image, image resolution, and size information in a real space.

In addition, the labeling method of the present disclosure may reduce time and cost of annotating large amounts of data on an object and may be easily used even by a user without related knowledge, by labeling 6DoF of the object, storing a coordinate value of the 6DoF of the object as a text file, and displaying an interface where annotations may be entered according to the stored 6DoF coordinate value. Furthermore, according to an embodiment of the present disclosure, since the time to annotate data is reduced, the total research time may also be reduced.

The present disclosure may significantly reduce time and cost required for data annotation by automating and simplifying parts of annotation work by estimating the 6DoF of a 3D object on a 2D image.

The present disclosure may be applied to active learning technology of estimating the 6DoF of a 3D object on a 2D image, recognizing which data points require additional annotation for a model, and selecting additional training data, thereby efficiently expanding data and improving performance of the model.

The present disclosure may provide a real-time annotation function of annotating streaming data or video in real time by estimating the 6DoF of a 3D object on a 2D image and may thus be used in application fields such as autonomous driving of vehicles, real-time video surveillance, and robot visual recognition.

The present disclosure may provide a high-precision labeling function of more accurately annotating location, direction, size, and shape of an object by estimating the 6DoF of a 3D object in a 2D image, thereby providing applications in fields such as medical imaging, aerospace, and precision manufacturing.

The present disclosure may provide a segmentation labeling function of accurately extracting a boundary of an object in an image and segmenting the interior of the object at the pixel level by estimating the 6DoF of a 3D object in a 2D image, thereby providing applications in fields such as medical imaging, intelligent vehicles, environmental monitoring, and robot vision.

The present disclosure may provide a 3D data annotation function of generating annotations for 3D point clouds, 3D models, or 3D scan data by estimating the 6DoF of a 3D object in a 2D image, thereby providing applications in fields such as industrial robots, virtual reality, architectural and environmental modeling.

The components described in the embodiments may be implemented by hardware components including, for example, at least one digital signal processor (DSP), a processor, a controller, an application-specific integrated circuit (ASIC), a programmable logic element, such as a field programmable gate array (FPGA), other electronic devices, or combinations thereof. At least some of the functions or the processes described in the embodiments may be implemented by software, and the software may be recorded on a recording medium. The components, the functions, and the processes described in the embodiments may be implemented by a combination of hardware and software.

The method according to embodiments may be written in a computer-executable program and may be implemented as various recording media such as magnetic storage media, optical reading media, or digital storage media.

Various techniques described herein may be implemented in digital electronic circuitry, computer hardware, firmware, software, or combinations thereof. The implementations may be achieved as a computer program product, for example, a computer program tangibly embodied in a machine readable storage device (a computer-readable medium) to process the operations of a data processing device, for example, a programmable processor, a computer, or a plurality of computers or to control the operations. A computer program, such as the computer program(s) described above, may be written in any form of a programming language, including compiled or interpreted languages, and may be deployed in any form, including as a stand-alone program or as a module, a component, a subroutine, or other units suitable for use in a computing environment. A computer program may be deployed to be processed on one computer or multiple computers at one site or distributed across multiple sites and interconnected by a communication network.

Processors suitable for processing of a computer program include, by way of example, both general and special purpose microprocessors, and any one or more processors of any kind of digital computer. Generally, a processor will receive instructions and data from a read-only memory or a random-access memory, or both. Elements of a computer may include at least one processor for executing instructions and one or more memory devices for storing instructions and data. Generally, a computer also may include, or be operatively coupled to receive data from or transfer data to, or both, one or more mass storage devices for storing data, e.g., magnetic, magneto-optical disks, or optical disks. Examples of information carriers suitable for embodying computer program instructions and data include semiconductor memory devices, e.g., magnetic media such as hard disks, floppy disks, and magnetic tape, optical media such as compact disk read-only memory (CD-ROM) or digital video disks (DVDs), magneto-optical media such as floptical disks, read-only memory (ROM), random-access memory (RAM), flash memory, erasable programmable ROM (EPROM), or electrically erasable programmable ROM (EEPROM). The processor and the memory may be supplemented by, or incorporated in special purpose logic circuitry.

In addition, non-transitory computer-readable media may be any available media that may be accessed by a computer and may include both computer storage media and transmission media.

Although the present specification includes details of a plurality of specific embodiments, the details should not be construed as limiting any invention or a scope that can be claimed, but rather should be construed as being descriptions of features that may be peculiar to specific embodiments of specific inventions. Specific features described in the present specification in the context of individual embodiments may be combined and implemented in a single embodiment. On the contrary, various features described in the context of a single embodiment may be implemented in a plurality of embodiments individually or in any appropriate sub-combination. Moreover, although features may be described above as acting in specific combinations and even initially claimed as such, one or more features from a claimed combination can in some cases be excised from the combination, and the claimed combination may be changed to a sub-combination or a modification of a sub-combination.

Likewise, although operations are depicted in a predetermined order in the drawings, it should not be construed that the operations need to be performed sequentially or in the predetermined order, which is illustrated to obtain a desirable result, or that all of the shown operations need to be performed. In specific cases, multitasking and parallel processing may be advantageous. In addition, it should not be construed that the separation of various device components of the aforementioned embodiments is required in all types of embodiments, and it should be understood that the described program components and devices are generally integrated as a single software product or packaged into a multiple-software product.

The embodiments disclosed in the present specification and the drawings are intended merely to present specific examples in order to aid in understanding of the present disclosure, but are not intended to limit the scope of the present disclosure. It will be apparent to one of ordinary skill in the art that various modifications based on the technical spirit of the present disclosure, as well as the disclosed embodiments, can be made.

What is claimed is:

1. A labeling method of estimating six degrees of freedom (6DoF) of an object, the labeling method comprising:
identifying a center coordinate of an object included in an image;
converting the center coordinate into object location information in a real space; and
visualizing 6DoF of the object by labeling the 6DoF based on the object location information.

2. The labeling method of claim 1, wherein
the converting of the center coordinate comprises:
determining a size of a real space corresponding to a pixel of the image based on an actual size of a space, where the object is located in a real space, and resolution of the image; and
determining the object location information in the real space based on the center coordinate of the object and the size of the real space corresponding to the pixel of the image.

3. The labeling method of claim 2, wherein
the determining of the object location information comprises determining an x value of the object location information in the real space using an X value of the center coordinate, an actual horizontal length of a space visible on the image, and a resolution horizontal value of the image.

4. The labeling method of claim 2, wherein
the determining of the object location information comprises determining a y value of the object location information in the real space using a Y value of the center coordinate, an actual vertical length of a space visible on the image, and a resolution vertical value of the image.

5. The labeling method of claim 2, wherein
the determining of the object location information comprises determining a z value of the object location information in the real space by inputting an x value of the object location information in the real space and a y value of the object location information in the real space to a matrix representing a relationship between the x value of the object location information in the real space, the y value of the object location information in the real space, and the z value of the object location information in the real space.

6. The labeling method of claim 1, further comprising:
determining a camera parameter representing a relationship between a camera and the object based on information about a location and rotation of the camera, the object location information in the real space, and information about the rotation,
and the visualizing of the 6DoF comprises labeling a location of the object existing in three-dimensions in the image of two-dimensions by applying a camera parameter to the object location information in the real space and performing visualization.

7. The labeling method of claim 6, wherein
the visualizing of the 6DoF comprises displaying an interface for inputting annotations according to the object location information in the real space and the information about the rotation.

8. A labeling device for estimating six degrees of freedom (6DoF) of an object, the labeling device comprising:
a value movement portion configured to identify a center coordinate of an object included in an image;
a converter configured to convert the center coordinate into object location information in a real space; and
a visualizer configured to visualize 6DoF of the object by labeling the 6DoF based on the object location information.

9. The labeling device of claim 8, wherein
the converter is further configured to:
determine a size of a real space corresponding to a pixel of the image based on an actual size of a space, where the object is located in a real space, and resolution of the image; and
determine the object location information in the real space based on the center coordinate of the object and the size of the real space corresponding to the pixel of the image.

10. The labeling device of claim 9, wherein
the converter is further configured to determine an x value of the object location information in the real space using an X value of the center coordinate, an actual horizontal length of a space visible on the image, and a resolution horizontal value of the image.

11. The labeling device of claim 9, wherein
the converter is further configured to determine a y value of the object location information in the real space using a Y value of the center coordinate, an actual vertical length of a space visible on the image, and a resolution vertical value of the image.

12. The labeling device of claim 9, wherein
the converter is further configured to determine a z value of the object location information in the real space by inputting an x value of the object location information in the real space and a y value of the object location information in the real space to a matrix representing a relationship between the x value of the object location information in the real space, the y value of the object location information in the real space, and the z value of the object location information in the real space.

13. The labeling device of claim 8, wherein
the visualizer is further configured to:
determine a camera parameter representing a relationship between a camera and the object based on information about a location and rotation of the camera, the object location information in the real space, and information about the rotation; and
label a location of the object existing in three-dimensions in the image of two-dimensions by applying a camera parameter to the object location information in the real space and perform visualization.

14. The labeling device of claim 13, wherein
the visualizer is further configured to display an interface for inputting annotations according to the object location information in the real space and the information about the rotation.
